(19) United States
(12) Patent Application Publication
(10) Pub. No.: US 2010/0082420 A1
(43) Pub. Date: Apr. 1, 2010

(54) SYSTEM AND METHOD FOR BENEFIT NOTIFICATION

(76) Inventors: Greg Trifiletti, San Francisco, CA (US); Joseph J. Mirizzi, Copperopolis, CA (US); Prakash Prem Hariramani, San Francisco, CA (US); Lauren White, San Bruno, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/566,319

(22) Filed: Sep. 24, 2009

Related U.S. Application Data
(60) Provisional application No. 61/236,234, filed on Aug. 24, 2009.
(60) Provisional application No. 61/100,205, filed on Sep. 25, 2008.

(51) Int. Cl. G06Q 30/00; G06Q 20/00; G06F 15/16

(52) U.S. Cl. 705/14.27; 705/14.38; 709/204

(57) ABSTRACT

A system and method for generating and sending benefit notifications is disclosed. A consumer can conduct a transaction at a merchant. The consumer may receive a notification containing a reward status indicator. The reward status indicator may be text or a figure that indicates a status of a consumer's purchases toward a reward threshold. With this notification, the consumer can be aware both of how many rewards she has already earned, and how many more rewards she may need to obtain to redeem any rewards. The benefit notification message may be sent while the consumer is still near the merchant, such that that the consumer can receive the message with enough time to act on the reward information.

### CROSS-REFERENCES TO RELATED APPLICATIONS

The present application claims benefit under 35 U.S.C. §119(e) of U.S. Provisional Patent Application No. 61/100,205, entitled “Mobile Alert and Offer System,” filed Sep. 25, 2008, and U.S. Provisional Patent Application No. 61/236,234, entitled “System and Method for Benefit Notification,” filed Aug. 24, 2009, the entire disclosures of which are incorporated herein by reference for all purposes.

### BACKGROUND

Merchants can use reward programs to encourage greater sales. A merchant may provide frequent purchaser cards that can receive a stamp upon each purchase, or reward coupons in the mail. Consumers may be enrolled in these reward program, or otherwise be eligible for rewards. However, often the consumer may be unaware of the reward program or forget her status in earning rewards. The consumer can lose the frequent purchaser card and have no way of knowing how many rewards have been earned so far. This can lead to a consumer purchasing different products, or not enough products, than she otherwise would have if she had been aware of the reward program. Furthermore, the consumer may be eligible to redeem a reward without being aware of this.

Embodiments of the invention address these and other problems, individually and collectively.

### BRIEF SUMMARY

Systems and methods for providing notifications of reward information related to payment transactions are disclosed. The reward notification system can be implemented using one or more computer apparatuses and databases. In embodiments of the invention, a consumer may earn rewards for some purchases, and can receive an alert message regarding the rewards. The alert message may indicate how far a consumer is from redeeming rewards under a reward program, or other suitable information. The consumer may receive multiple messages that can show the consumer getting progressively closer to a reward threshold for redemption. The one or more computer apparatuses can send the alert message to the consumer in near real time, such that the consumer may receive the message while still at the merchant's store.

One embodiment of the invention is directed to a method. The method comprises receiving a first transaction notification message comprising a first reward status indicator at a notification device, wherein the first reward status indicator indicates a first status of a consumer's purchases toward a reward threshold, and receiving a second transaction notification message comprising a second reward status indicator at the notification device, wherein the second reward status indicator indicates a second status of the consumer's purchases toward the reward threshold, wherein the second status is closer to the reward threshold than the first status.

Another embodiment is directed to a method. The method comprises receiving transaction data relating to a purchase transaction conducted by a consumer at a merchant, determining, using one or more computer apparatuses, a first status of the consumer's purchases toward a reward threshold, generating, using the one or more computer apparatuses, a first transaction notification message comprising a first reward status indicator, wherein the first reward status indicator indicates the first status, sending the first transaction notification message to a notification device used by the consumer, determining, using the one or more computer apparatuses, a second status of the consumer's purchases toward the reward threshold, wherein the second status is closer to the reward threshold than the first status, generating, using the one or more computer apparatuses, a second transaction notification message comprising a second reward status indicator, wherein the second reward status indicator indicates the second status, and sending the second transaction notification message to the notification device used by the consumer.

Another embodiment is directed to a method. The method comprises enrolling, using one or more computer apparatuses, a reward program with a payment processing network, conducting a first purchase transaction with a consumer, sending transaction data regarding the first purchase transaction to the payment processing network, wherein the payment processing network sends the consumer a first transaction notification message comprising a first reward status indicator, wherein the first reward status indicator indicates a first status of a consumer's purchases toward a reward threshold, conducting a second purchase transaction with the consumer, and sending transaction data regarding the second purchase transaction to the payment processing network, wherein the payment processing network sends the consumer a second transaction notification message comprising a second reward status indicator, wherein the second reward status indicator indicates a second status of a consumer's purchases toward the reward threshold, and wherein the second status is closer to the reward threshold than the first status.

These and other embodiments of the invention are described in further detail below.

### BRIEF DESCRIPTION OF THE DRAWINGS

FIG. 1 shows an enrollment system, according to an embodiment of the invention.

FIG. 2 shows a transaction system, according to an embodiment of the invention.

FIG. 3 shows a loyalty system, according to an embodiment of the invention.

FIG. 4 is a flowchart illustrating a method according to an embodiment of the invention.

FIG. 5 shows a block diagram of an embodiment of a notification device.

FIG. 6 shows a block diagram of an embodiment of a computer apparatus.

### DETAILED DESCRIPTION

Embodiments of the invention are directed to systems and methods for providing notifications of reward information related to payment transactions.

In certain embodiments, the notifications can comprise alert messages. A consumer may receive an appropriate alert message after conducting a transaction. The alert message may contain information relating to the transaction, and information relating to any applicable reward programs that the consumer is eligible for or participates in. In some embodiments, certain purchase transactions conducted by the consumer may be eligible to earn associated rewards, for a reward program. At a certain level of earned rewards (a “reward threshold”), the consumer can redeem the earned rewards to obtain a benefit, such as a rebate coupon or free product. The reward threshold may comprise a selectable number of purchases made at a merchant, a minimum point level, or other suitable threshold.

Illustratively, a consumer may make two purchases of coffee at the same coffee shop in a calendar month, using a portable consumer device such as a credit card. The coffee shop can process the purchase transactions. In each transaction, during the credit card authorization process (which includes a request that an issuer of the credit card approve of the transaction), a loyalty program processing platform (which may be embodied by one or more suitable computer apparatuses running appropriate software) can qualify the transaction for any rewards programs. For example, the coffee shop may have a current promotion, where a consumer will receive a free cup of coffee after purchasing 4 cups of coffee during the month. The loyalty program processing platform may adjust stored consumer data relating to the consumer's accumulated rewards to reflect that the consumer now has purchased 2 of the 4 cups of coffee towards earning a free cup of coffee. After the second purchase, the consumer can then receive a reward notification, such as a message on her wireless phone, stating her status. For instance, the consumer may receive a text message stating “You have just made 2 of 4 coffee purchases towards a free cup of coffee.” With this method, the consumer will be apprised of her current reward situation, even before earning the free coffee. This can provide an incentive for her to purchase more coffee or other reward eligible products or services.

In certain implementations, the consumer may receive the reward notification before she leaves the coffee shop. That is, she can receive the reward notification in near real time (e.g., less than about 5 minutes, 1 minute, or 30 seconds). This can allow the consumer to more easily conduct another purchase or redeem an earned reward, because the consumer can make an additional purchase at the coffee shop before she leaves the coffee shop. In certain embodiments, the generation and sending of the reward notification message can happen in parallel to the payment authorization. In some embodiments, the generation and sending of the reward notification message can happen after the payment authorization request process. In either situation, the benefit notification message can be sent fast enough (such as within minutes or even seconds of the transaction) so that the consumer will receive the message with enough time to act on the reward information.

In certain embodiments, a payment processing network can be used in performing all or portions of the above-described methods. A consumer may use a portable consumer device to conduct a transaction with a merchant. An example of a portable consumer device can be a payment card issued by a bank (an “issuer”) and used by consumers to make purchases of goods or services. In an exemplary payment transacting using a payment card, a merchant's payment terminal can read data from the card. The data may include the account number and expiration data associated with the card, as well as any suitable verification values. The payment terminal can then send the card data, along with other transaction information (e.g., the transaction amount) to the consumer's bank by way of a payment processing network, such as VisaNet™. The bank that issued the payment card (the “issuer”) can send an authorization response message to the merchant, via the payment processing network.

The authorization response message can indicate to the merchant and the consumer that the transaction is approved (or disapproved). While routing the various transaction messages (e.g., authorization request and authorization response messages), the payment processing network can also route messages relating to the reward program, as described in greater detail below.

Other specific examples of embodiments of the invention are described in further detail below and with reference to the drawings.

I. System

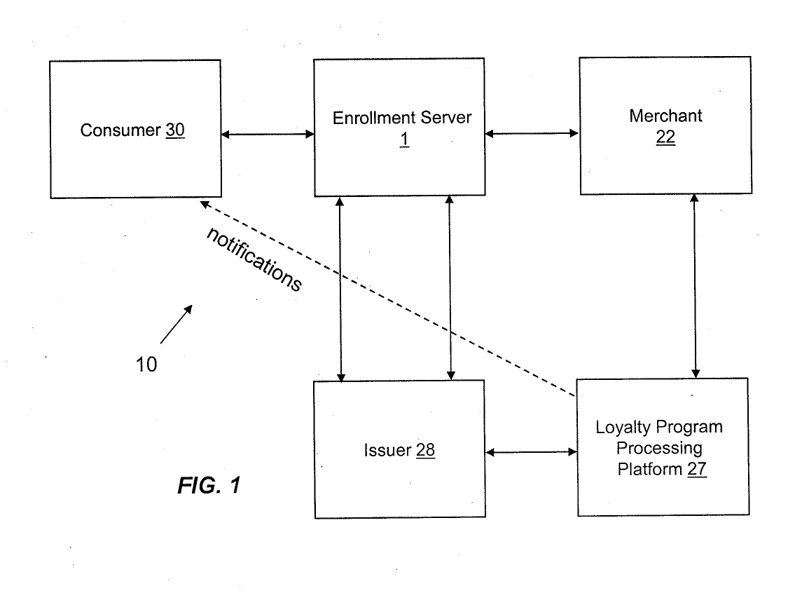

FIG. 1 is a diagram illustrating an enrollment system 10 in accordance with an embodiment of the invention. Other systems according to embodiments of the invention may include fewer or more components than are specifically shown in FIG. 1.

The enrollment system 10 can be used to enroll various consumers and merchants into one or more reward programs. The system 10 includes an enrollment server 1, an issuer 28, a merchant 22, and a loyalty program processing platform 27, operatively coupled together. In certain embodiments, the enrollment server 1 can comprise a portion of the loyalty program processing platform 27. A consumer 30 may communicate with the enrollment system 10. In FIG. 1, only one merchant 22 and one consumer 30 is shown for clarity of illustration, however certain embodiments contemplate that more such entities may communicate with enrollment server 1.

A consumer may enroll in a reward program by accessing the enrollment server 1 in a number of ways. For instance, using a client computer (not shown), the consumer 30 may log onto a website (not shown) hosted by, or in communication with, the enrollment server 1. The consumer 30 can then enter appropriate consumer data that can be sent to and stored in the loyalty program processing platform 27. Consumer data can comprise the consumer's name, the consumer's preferences, an account number (such as a bank account associated with the consumer's portable consumer device) used by the consumer, an indication of a reward program that the consumer is participating in, contact information for the consumer, etc. Alternatively, the consumer may fill out a form at the merchant 22. The merchant 22 can then enter the consumer data into the enrollment server 1, or may send batches of consumer forms to an appropriate party, who in turn can enter the consumer data into the enrollment server 1.

In another implementation, the enrollment server 1 may be provided the consumer data directly from records kept by the merchant 22 or issuer 28, or by other suitable methods.

After a consumer 30 accesses the enrollment server 1, a consumer account is created and can include the consumer data. The enrollment server 1 may forward the consumer account information to the loyalty program processing platform 27 for storage and reward processing. In various embodiments, the consumer 30 may access the enrollment server 1 (or loyalty program processing platform 27) to update the consumer account information, such as to change her contact information or a reward program that she is associated with. The contact information can include, among other things, mobile contact information in which the consumer 30 may be contacted through a mobile device (not shown). For example, the mobile contact information includes a mobile phone number. Using the mobile device, the consumer 30 can receive Short Message Service (“SMS”) messages and other types of instant mobile messages. In certain implementations, the consumer 30 may select when she wishes to receive transaction notification messages that comprise reward status indicators. For example, the consumer 30 may choose to receive two transaction notification messages per reward threshold. In this example, the consumer 30 may receive a transaction notification message once upon reaching a status of 50% of a reward threshold, and may receive a second message upon reaching the reward threshold. In another example, the consumer 30 may elect to receive a transaction notification message after every purchase transaction conducted using one or more portable consumer devices (e.g., one or more payment cards). In this latter example, each transaction notification message may include reward status indicators, or less than all transaction notification messages may include reward status indicators.

The merchant 22 and the issuer 28 may also enroll one or more reward programs with the loyalty program processing platform 27 or may provide data to facilitate one or more reward programs to the loyalty program processing platform 27. For example, the issuer 28 may provide, to the enrollment server 1, consumer data for consumers that have previously authorized their enrollment in reward programs, or other consumer data such as portable consumer device information (e.g., account numbers, expiration dates, etc.).

The merchant 22 can also access the enrollment server 1 as described above to access the loyalty program processing platform 27 or may access the loyalty program processing platform 27 directly. After the merchant 22 is in communication with the loyalty program processing platform 27, the merchant can sign up for an existing reward program, or create a new reward program and enter the details of such programs into the enrollment server 1. The merchant 22 may provide to the enrollment server details of one or more reward programs, such as eligible purchases or other transactions, limitations on earning rewards (such as certain geographic regions, purchases made at certain times of day, etc), reward thresholds, reward offers that can be earned, preferred communication methods, allowed customers, message templates, etc. In certain embodiments, the enrollment server 1 can forward the enrollment information to the loyalty program processing platform 27. For example, the merchant 22 can enroll a reward program with the loyalty platform, such as by communicating with the enrollment server 1, which can then pass on the relevant information to be stored in the loyalty program processing platform 27. In some embodiments, the loyalty program processing platform 27 can incorporate some or part of the enrollment server 1, instead of being a separate entity. In such embodiments the consumer 30, merchant 22, and issuer 28 can communicate with a single entity comprising both the enrollment server 1 and the loyalty program processing platform 27.

The enrollment server 1 and the loyalty program processing platform 27 may be operated by the merchant 22, the issuer 28 or a payment processing organization such as Visa. In certain embodiments, a payment processing network may comprise either or both the enrollment server 1 and the loyalty program processing platform 27. In other embodiments, either or both of the enrollment server 1 and the loyalty program processing platform 27 may comprise separate computer apparatuses that are in operative communication with one or more payment processing networks. Embodiments of computer apparatuses that may be used in enrollment system 10 will be described in greater detail below.

After enrollment, a notification device operated by the consumer 30 may receive reward notifications regarding purchases conducted with a merchant. In exemplary embodiments, notifications may be sent to a notification device operated by the consumer 30, in near real time, that contain reward information stored in loyalty program processing platform 27.

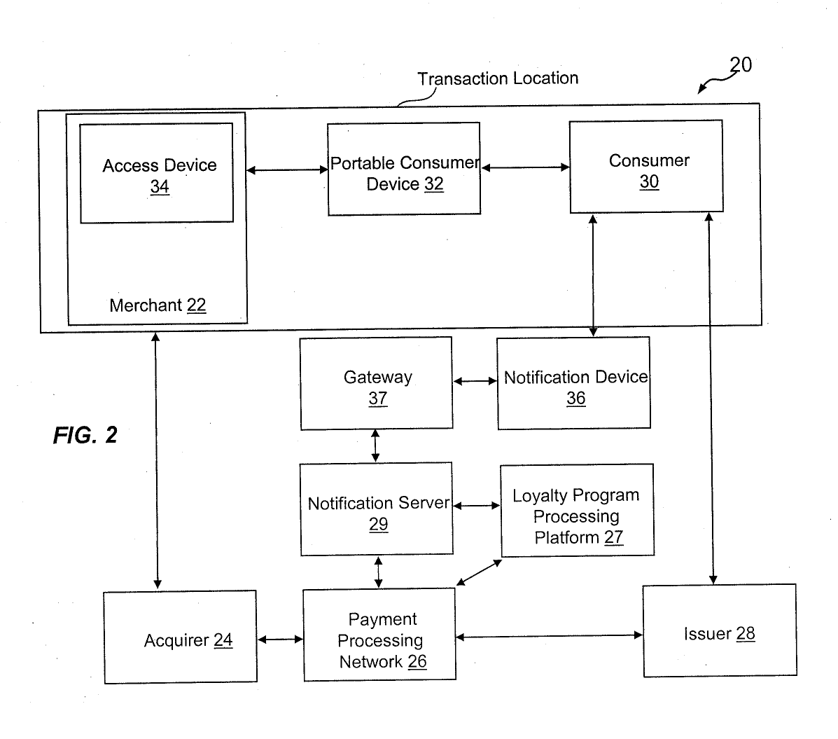

FIG. 2 is a block diagram of a notification system 20. The notification system 20 can be used by a consumer 30, and can include one or more of a portable consumer device 32, a merchant 22, an access device 34 associated with the merchant 22, one or more computer apparatuses operated by an acquirer 24, a payment processing network (PPN) 26, one or more computer apparatuses operated by an issuer 28, a notification server 29, a message gateway 37, a loyalty program processing platform 27, and a notification device 36. Although one of each of the above listed entities are shown, there may be any suitable number of any of these entities in notification system 20.

In a typical payment transaction, a consumer 30 may purchase goods or services at the transaction location of the merchant 22 using a portable consumer device 32 such as a credit card. The merchant 22 can send an authorization request message to the issuer 28 via the payment processing network 26. After the issuer 28 makes a decision on whether or not to authorize or not authorize the transaction, the issuer 28 may send an authorization response message back to the merchant via the payment processing network 26 and the acquirer 24. During or soon after authorization of the transaction, the loyalty program processing platform 27 can qualify the transaction for one or more reward programs. If the transaction qualifies for a reward program, the loyalty program processing platform can send reward information to the notification server, which can generate a reward notification message. The reward information may contain a phrase that indicates the consumer's status towards a reward threshold, or other suitable information. The reward notification message can be sent to the gateway 37, which can route the reward notification message to the notification device 36. The consumer 30 can receive the reward notification message while still at or near the transaction location of the merchant 22.

The consumer 30 can be an individual or organization such as a business that is capable of purchasing goods or services or making any suitable transaction with merchant 22.

Portable consumer device 32 refers to any suitable device that allows the transaction to be conducted with merchant 22. Portable consumer device 32 may be in any suitable form. For example, suitable portable consumer devices 32 can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of portable consumer devices 32 include cellular phones, personal digital assistants (PDAs), pagers, payment cards, security cards, access cards, smart media, transponders, and the like. In some cases, portable consumer device 32 may be associated with an account of consumer 30 such as a credit or debit account. The account may be maintained by issuer 28, or other suitable entity. In some embodiments, the portable consumer device 32 and the notification device 36 may be embodied by a single device (e.g., when a wireless phone is capable of both making payment transactions and receiving phone calls).

Merchant 22 refers to any suitable entity or entities that make a transaction with consumer 30. Merchant 22 may use any suitable method to make the transaction. For example, merchant 22 may use an e-commerce business to allow the transaction to be conducted by merchant 22 through the Internet. Other examples of merchant 22 include a department store, a gas station, a drug store, a grocery store, or other suitable business.

Access device 34 may be any suitable device for communicating with merchant 22 and for interacting with portable consumer device 32. Some examples of access devices 34 include Point-Of-Sale (POS) devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, websites, servers, and the like. Access device 34 may use any suitable contact or contactless mode of operation to send or receive data from portable consumer devices 32.

If the access device 34 is a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, magnetic stripe readers, etc. to interact with portable consumer device 32.

As used herein, the “transaction location” refers to the geographic location of where a transaction would take place, from the point of view of the consumer 30. In exemplary embodiments, the transaction location may comprise an area such that the consumer 30 would consider heading back to the access device 34 a negligible burden. For example, at a “brick and mortar” store such as a grocery store, the transaction location would refer to the area within the storefront (e.g., within the grocery store). In certain embodiments, the transaction location may include both the physical storefront, and the nearby area such as the store parking lot. For some types of outside located merchants, such as take-out windows or other types of vendor stalls, the transaction location can refer to an area nearby the merchant, such as within a short walking distance for the consumer (e.g., less than 500 feet around the physical location of the merchant).

In certain implementations, the consumer 30 may conduct purchases transactions with the merchant 22 at a distance, such as over a phone or online using the Internet. The transaction location for online transactions may comprise the area around the consumer 30 while conducting the transaction. For example, a consumer 30 may use a computer, located in a home living room, to conduct a purchase transaction over the Internet. The transaction location may comprise the living room of the house. In certain embodiments, the consumer 30 can receive a transaction notification message in near real time. In certain embodiments, “near real time” can comprise the maximum amount of time available for a consumer to receive the transaction notification message while within the transaction location. Near real time may comprise less than an hour, such as thirty minutes, or less than thirty minutes including five minutes, two minutes, etc.

The acquirer 24 can be an suitable entity that is associated with the merchant 22. In some embodiments, the issuer 28 and the acquirer 24 could be embodied by the same entity or organization. The issuer 28 can be any suitable entity that may open and maintain an account associated with portable consumer device 32 for the consumer 30. Some examples of issuers may be a bank, a business entity such as a retail store, or a governmental entity. In many cases, the issuer 28 may issue the portable consumer device 32 associated with the account of the consumer 30.

Purchase transaction messages and notification messages can be routed through the payment processing network 26. The payment processing network 26 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 26 may have or operate a server computer (which is an example of a computer apparatus) and may include a database. The database may include any hardware, software, firmware, or combination of the preceding for storing and facilitating retrieval of information. Also, the database may use any of a variety of data structures, arrangements, and compilations to store and facilitate retrieval of information. The server computer may be coupled to the database and may include any hardware, software, other logic, or combination of the preceding for servicing the requests from one or more client computers. Server computer may use any of a variety of computing structures, arrangements, and compilations for servicing the requests from one or more client computers.

The payment processing network 26 can also communicate with a notification server 29, and both of them may communicate with the loyalty program processing platform 27. The notification server 29 can create a transaction notification message (also known as a transaction alert message), such as a reward notification message, using the payment transaction information and reward information from the loyalty program processing platform 27. The reward information can include, among other things, rewards or rewards points the consumer earned for conducting the payment transaction. In addition, the reward information may also include other information, such as the number of reward points or the number of purchases that the consumer needs in order to qualify for a free item or an elite status. This number may be associated with a reward threshold.

The notification server 29 may be a powerful computer apparatus or a cluster of computer apparatuses. For example, the notification server 29 can be a large mainframe, a minicomputer cluster, or a group of servers functioning as a unit. In one example, the notification server 29 may be a database server coupled to a Web server.

Notification server 29 includes a computer-readable medium (CRM) and a processor coupled to the CRM.

During transaction processing, the loyalty program processing platform 27 can qualify the transaction for any of a plurality of reward programs, and send applicable reward information to the notification server 29. The loyalty program processing platform 27 can comprise a computer apparatus or cluster of computer apparatuses. The loyalty program processing platform 27 can contain databases to store data relating to a plurality of enrolled reward programs, notification message templates, and other data. The loyalty program processing platform 27 can also include a reward engine that includes code, stored on a tangible medium such as a database memory, to direct a computer processor to process reward transactions, such as qualifying purchase transactions and generating reward information. In certain embodiments the loyalty program processing platform 27 may comprise a separate computer apparatus in operative communication with notification server 29 or payment processing network 26. In some embodiments, the loyalty program processing platform 27 may comprise a portion of notification server 29 or payment processing network 26.

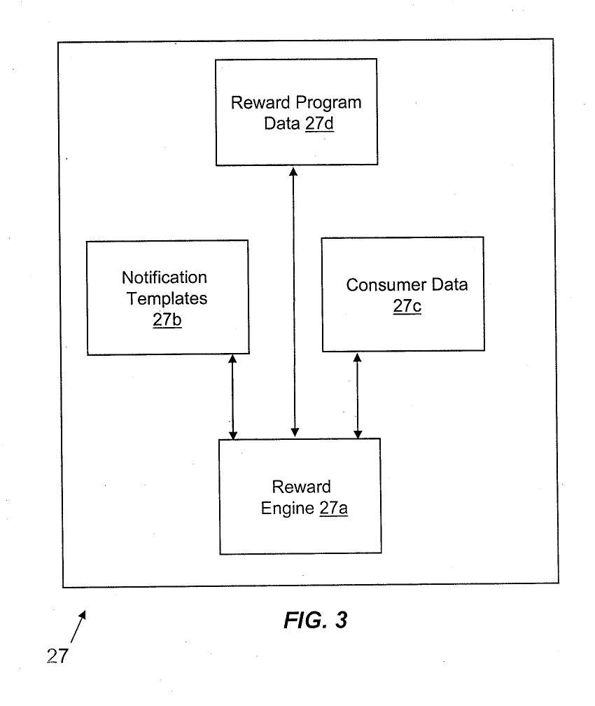

FIG. 3 is a diagram illustrating more details about the loyalty program processing platform 27. The loyalty program processing platform 27 includes one or more databases for storing reward program data 27d, notification templates 27b, and consumer data 27c. The databases may comprise suitable tangible computer readable media, such as hard drives or other computer memory. The consumer database 27c can comprise the information provided about the consumer in the enrollment stage, such as consumer name, consumer preferences, an account number (such as a bank account associated with the consumer's portable consumer device), enrolled reward programs, contact information for the consumer, etc. The consumer database 27c can also comprise the reward history of the enrolled consumers, such as how many rewards have been earned, how many rewards have been redeemed, how many rewards are still required to reach a reward threshold, etc. In exemplary implementations, the consumer database 27c can include the status of the consumer's purchases towards each reward threshold of one or more reward programs.

The reward program database 27d can comprise information on the reward program, such as participating merchants, reward thresholds, what transactions will qualify for rewards, a history of merchant participation in various reward programs, etc. In certain implementations, each individual reward program may have a separate reward program database 27d. In other implementations, the plurality of reward programs may share one or more databases of reward program data 27d. Loyalty program processing platform 27 may also comprise a database of notification templates 27b. The notification templates can comprise one or more templates of reward notification messages that can be sent to the consumer 30. The templates may contain a fraction or other reward status indicators that can alert a consumer as to her status towards a reward threshold. For example, notification templates database 27b can comprise data for the following messages:
“______ of ______ purchases made towards a reward of ______.”;
“only ______ purchases of ______ required to earn ______.”;
“______/______ of the way towards ______.”;
“______ way towards earning ______.”.

Other suitable templates are contemplated in embodiments of the notification templates database 27b. The above templates be used to form fractions, which can indicate a consumer's reward status toward a particular reward threshold. Once filled in with the appropriate information, the above templates can quickly and effectively convey to consumers what their status comprises. Each template in the plurality of stored templates may be associated with one or more rewards programs stored in reward program database 27d. Thus, when a transaction has been qualified for a specific reward program, the associated template may be used to generate a reward notification message.

A reward engine 27a can correlate the information stored in databases 27b, 27c, and 27d, to qualify a transaction for rewards and to generate reward information such as reward notification messages. The reward engine can comprise any suitable computer apparatus or networked group of computers, and can include code, stored on a computer readable medium, to direct a computer processor to perform the various loyalty program processing platform 27 functions described herein. The reward engine can receive information regarding a purchase transaction (“transaction data”) from any suitable source, such as from the merchant 22, the payment processing network 26, or the notification server 29. Included in the information can be an identifier for the merchant 22, and an identifier for the consumer 30.

In certain implementations, there can also be included in the transaction data an indicator as to the specific product or services purchased, or to a category of the products or services. For example, the stock keeping units (SKU) or universal product codes (UPC) of the products may be provided. In some of these embodiments, the loyalty program processing platform 27 may be located at the merchant 22, and may generate and then provide the reward notification message to the notification server 29 or gateway 37. In some of these embodiments, the product indicator (e.g. a SKU) may be provided as part of an authorization request routed by the payment processing network 26. In other embodiments, the purchase amount (i.e., transaction cost) may be provided, which may be correlated with the merchant identifier to determine a product category. In one example, a purchase for 4 dollars may be made at a coffee shop. The reward program database 27d may indicate that every 3 dollars spent at the coffee shop comprises a purchase of one cup of coffee. Thus, as the purchase amount was more than three dollars but less than six (which would comprise two cups of coffee), the reward engine 27a can designate the transaction as a purchase of one cup of coffee, and allocate the requisite rewards.

The notification server 29 can combine the reward information from the loyalty program processing platform 27 with payment transaction data to generate a reward notification message, which can then be sent to the gateway 37. The gateway 37 can comprise a notification gateway that collects and forwards notification messages to the consumer notification device 36. In one embodiment, the notification gateway 37 comprises a mobile gateway that sends instant or near instant (i.e. in near real time) notifications to notification device 36. The gateway 37 can send messages across various delivery channels, such as emails, text messages (including SMS messages), instant messaging, posting to websites or RSS feeds, recorded phone messages, etc.

In certain embodiments, the gateway 37 and the notification server 29 may comprise portions of the same computer apparatus or networked system of computer apparatuses. In other embodiments, the gateway 37 and the notification server 29 may comprise separate systems in operative communication with each other. Furthermore, in certain implementations, any of the functions of the gateway 37 or the notification server 29 may be performed by portions of the payment processing network 26.

Consumer notification device 36 can be any suitable device for receiving the notifications, and can provide the notifications to consumer 30. As used herein, a notification includes an alert and/or reward information. Notification device 36 may be in any suitable form. For example, suitable notification devices 36 can be hand-held and compact so that they can fit into a consumer's wallet and/or pocket (e.g., pocket-sized). Some examples of notification device 36 include mobile phones, personal digital assistants (PDAs), desktop or laptop computers, pagers, payment cards, security cards, access cards, smart media, transponders, and the like. In some embodiments, notification device 36 and portable consumer device 32 are embodied in the same device. In certain embodiments, the notification device 36 can be located within the transaction location when receiving a notification (not shown), along with the consumer 30. In other embodiments, the notification device 36 can be located outside the transaction location when receiving a notification, and can send or project the notification to the consumer 30 within the transaction location.

II. Method

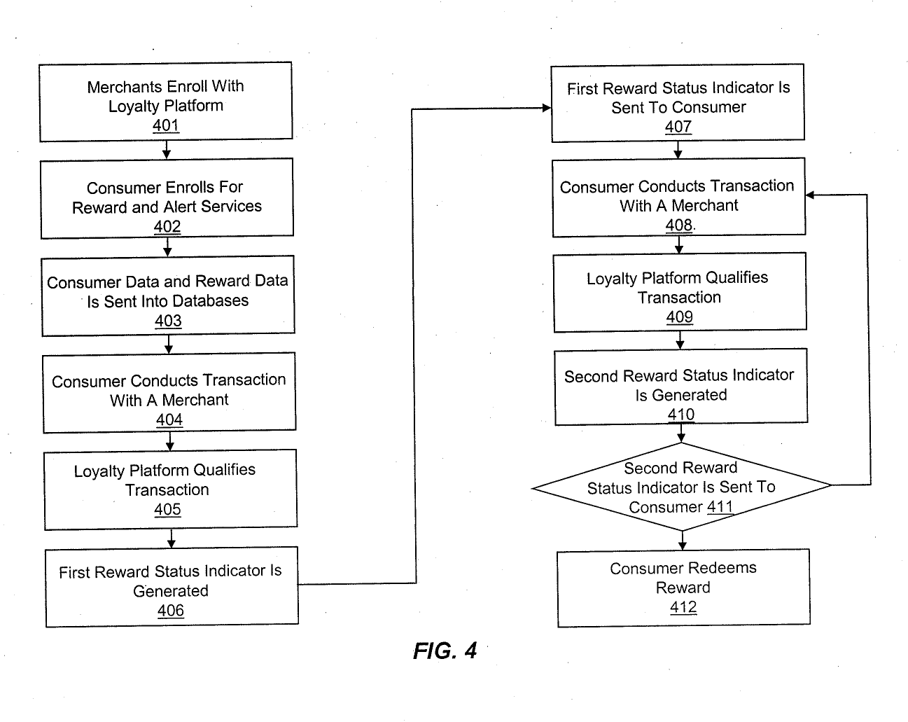

FIG. 4 is a flowchart illustrating a reward notification process according to an embodiment of the present invention. As shown in FIG. 4, the merchant 22 can first enroll a reward program with the loyalty program processing platform 27 (step 401). The consumer 30 can also enroll for reward programs and notification services, in step 402. The reward program data provided by the merchant 22, and the consumer data provided by the consumer 30, can both be stored in the loyalty program processing platform 27 (step 403). The consumer 30 can the conduct a first transaction using the portable consumer device 32 with the merchant 22 (step 404). The transaction in step 403 may be a purchase of goods or services. For example, the consumer 30 can purchase three books at a merchant 22 comprising a bookstore, using a credit card which can be read by access device 34.

An authorization request message comprising transaction data regarding the transaction can be generated by a processor in the access device 34. The transaction data may comprise, for example, the BIN (bank identification number) and expiration date associated with the portable consumer device 32, the purchase amount, and a merchant code such as a merchant category code (MCC). In certain embodiments, the transaction data may also include a product indicator such as a SKU. The authorization request message is then forwarded by the merchant 22 to the acquirer 24, which can then forward the message to the issuer 28 by way of the payment processing network 26. After the issuer 28 receives the authorization request message, the issuer 28 sends an authorization response message back to the merchant 22, by way of the payment processing network 26 and the acquirer 24. The authorization response message can indicate whether or not the current transaction is authorized.

If the consumer 30 or the merchant 22 is enrolled in a reward program, the payment processing network 26 can also send the transaction data to the loyalty program processing platform 27. In certain embodiments, the payment processing network 26 can send the transaction data directly to the loyalty program processing platform 27. In some embodiments, the transaction data can first be sent to the notification server 29, which can then forward the transaction data to loyalty program processing platform 27. In order for the payment processing network 26 to determine whether the authorization request is may qualify for a reward program, exemplary embodiments of the payment processing network 26 can maintain a list of account numbers associated with consumers who are enrolled in reward programs registered with the loyalty program processing platform 27, along with a list of merchants enrolled in the registered reward programs. These lists can be synchronized with the databases of loyalty program processing platform 27 at regular intervals.

In step 405, the loyalty program processing platform 27 can qualify the transaction for one or more reward programs after receiving the transaction data regarding the purchase transaction conducted by the consumer 30 at the merchant 22. In certain implementations, the loyalty program processing platform 27 can compare the transaction data to one or more fields in the reward program database 27d. Each reward program may require a transaction to match a selectable number of fields in the reward program database 27d. For example, a reward program may require a minimum purchase amount at specific store locations of a chain of merchants. If the transaction information matches the fields for minimum purchase amount and specific store locations (i.e., the purchase amount met the threshold at a qualified store location), then the transaction can be qualified and the consumer 30 may earn rewards. Embodiments disclosed herein contemplate qualifying transactions by other suitable methods.

Once the transaction is qualified in step 405, a reward status indicator can be generated in step 406. The reward status indicator can be any suitable means to indicate the status of the consumer's purchases towards a reward threshold of a reward program. In exemplary embodiments, the reward threshold is the level at which a consumer can redeem the earned rewards, such as for a rebate or gift. The reward status indicator can comprise, for example, a phrase including a filled in template, as disclosed above with respect to the notification templates database 27b. In other examples, the reward status indicator can comprise a sound, symbol, picture, or other type of message. For example, the reward status indicator may comprise a star icon, or the words “almost there!”

In exemplary embodiments, the loyalty program processing platform 27 can generate the reward status indicator. The loyalty program processing platform 27 can determine the status of the consumer's purchases towards the reward threshold. The consumer's status, prior to the most recent transaction, can be stored in consumer database 27c. The loyalty program processing platform 27 can access the stored consumer's status, and add the rewards earned in the most recent transaction, to determine the current status. The loyalty program processing platform 27 can record the current status in the consumer database 27c, and can determine the reward status indicator, such as choosing the appropriate notification template.

In certain implementations, the reward program can be associated with a specific template, which can be used for all notifications regarding the reward program. In some implementations, the reward program may be associated with a plurality of templates. Each template in the plurality of templates may be used for specific purposes, such as for a range of statuses. For example, a reward program use at least three separate templates. When a consumer's purchase status is is between zero and sixty percent of the way towards a reward threshold, a first template may be used. While a consumer is greater than sixty percent, but has not earned enough rewards to reach a reward threshold, a second template may be used. And when a consumer reaches a reward threshold, a third template may be used until the consumer has redeemed her rewards. In other implementations, one or more reward programs may have multiple reward thresholds, such as at successively higher levels of rewards. A different template may be used for each reward threshold. For example, a template may state “Congratulations! You currently can redeem rewards for ______. Purchase ______ and you can redeem rewards for ______.”

Referring to step 407, the consumer 30 can receive the reward status indicator, such as by using the notification device 36. In embodiments, the consumer 30 can receive a transaction notification message that comprises the reward status indicator. In exemplary embodiments, the loyalty program processing platform 27 can generate a first transaction notification message comprising a first reward status indicator as described above, and can send the first transaction notification message to the consumer 30. The consumer 30 can receive the first transaction notification message using the notification device 36, such as a wireless phone. In certain implementations, the loyalty program processing platform 27 can generate the first reward status indicator, and can forward the first reward status indicator to the notification server 29. The notification server can then generate the first transaction notification message, such as by creating a text message comprising the first reward status indicator.

When first transaction notification message is generated, it can be sent, in embodiments, to the gateway 37 for delivery to the consumer 30. The gateway 37 may comprise a mobile gateway that can be in the form of one or more software applications running on one or more computer apparatuses that are tasked with delivery of messages to the appropriate delivery channel. In one embodiment, the gateway 37 may be part of the notification server 29. In another embodiment, the gateway 37 may be a third party entity that receives the transaction notification messages and sends the messages to an appropriate notification device.

In exemplary embodiments, the first transaction notification message is sent to the consumer 30 in near real time. The consumer 30 can thus receive the first transaction notification message while the consumer 30 is at the merchant 22, or within the transaction location. In one example, after buying a donut at a mall food court, the consumer 30 may receive a text message on her wireless phone stating “You just purchased 1 donut at FunTime Donuts. Buy 3 more to get a free sandwich!” The consumer 30 can receive this message in near real time, while the consumer is still located in the mall food court (i.e., within the transaction location). The text message can provide an incentive for the consumer 30 to go and purchase three more donuts, to get a free sandwich.

The consumer 30 can conduct another transaction, in step 408. This transaction may be motivated by the first transaction notification message as described above, or due to other reasons. The consumer 30 may conduct a second purchase transaction at the merchant 22. For example, the consumer 30 may purchase two more donuts in the mall food court described in the example above. As with the first purchase transaction of step 404, the merchant 22 may request authorization for the purchase. The loyalty program processing platform 27 can receive transaction data regarding the second purchase transaction. The loyalty program processing platform 27 can then qualify the transaction, in step 409. The loyalty program processing platform 27 can determine a second status of the consumer 30 and generate a second reward status indicator in step 410. The second reward status indicator can indicate a second status of the consumer 30's purchases toward the reward threshold.

In exemplary embodiments, the second status is closer to the reward threshold than the first status. For example, after the first purchase transaction of buying one donut (with a reward threshold of four donuts), the consumer 30 may have a first status of being ¼ of the way towards the reward threshold. After the second purchase transaction of buying two more donuts, the consumer 30 may have a second status of being ¾ of the way towards the reward threshold. In exemplary embodiments, the second status is “closer” to the reward threshold than the first status when the second status is greater than the first status. In another example, a first status of the consumer 30 may comprise the consumer's purchases are fifty percent of the way towards reaching a reward threshold. If the second status comprises purchases that are two-thirds of the way towards the reward threshold, or if the second status comprises the consumer reaching or exceeding the reward threshold, the second status is closer to the reward threshold than the first status.

In certain embodiments, the loyalty program processing platform 27 can forward the second reward status indicator to the notification server 29, which can generate a second transaction notification message. The second transaction notification message can be sent, by the gateway 37, to the consumer 30 in step 411. In exemplary embodiments, the consumer 30 can receive a transaction notification message after every purchase transaction with the merchant 22. In other embodiments, the consumer 30 may only receive a transaction notification message after selectable transactions. For example, the consumer 30 may receive a first transaction notification message after a first purchase transaction and a second transaction notification message after a second purchase transaction, but no further messages. The consumer 30 or the merchant 22 may also select other transaction notification schedules. The notification device 36 can receive the second transaction notification message, and can then display to the consumer 30 the second reward status indicator. For example, the consumer may receive a text message stating “You have now purchased 3 donuts at FunTime Donuts. Buy 1 more to get a free sandwich!” The consumer may then go and make another purchase at the merchant, and repeat the process starting at step 408.

In another example, the consumer may have reached a reward threshold in the purchase of step 408. The consumer may then redeem her reward in step 412. At that point, the merchant 22 may send a mobile or paper coupon to the consumer 30, and the next time that the consumer 30 comes into the store, she may use the coupon at the merchant 22 to get her reward, such as a free cup of coffee. In other embodiments, a statement credit or loyalty points can be awarded when a reward threshold is reached. In continuation of the example above, the consumer may have purchased three donuts in step 408, or may have gone back to the merchant and purchased one or more donuts when repeating step 408. In this example, the consumer 30 may have a status of achieving the reward threshold. Thus, the reward status indicator may indicate to the consumer that she is eligible to redeem her rewards. For instance, the reward status indicator may be the phrase “Free Sandwich!” or a happy face icon. In certain implementations, the consumer 30 may receive a second transaction notification message in step 411 stating “You have earned a free sandwich at FunTime Donuts!” The consumer may then receive her free sandwich in step 412.

In certain embodiments, the transaction notification messages described herein may include reward status indicators, and also may include additional information. This additional information may assist in making further purchases towards the reward threshold. For example, the transaction notification message may ask the consumer 30 if she wants to automatically add further purchases to her payment account. The consumer 30 may reply to the message or respond in other suitable ways. In this method, the consumer 30 can reach the reward threshold without having to wait in a checkout line. For example, after purchasing three cups of coffee, the consumer 30 may receive a transaction notification message stating “3 of 4 coffee purchases towards a free cup of coffee. Would you like to add 1 more coffee to your bill?” In exemplary implementations, this message may be received after the consumer 30 has paid for her coffee, but before she has picked up her purchase (i.e., the message is sent in near real time). The consumer 30 can respond to the message by sending a “yes” text message, selecting a yes button in the message, or by other suitable methods. After responding to the transaction notification message, the cost of the extra cup of coffee may be added to the consumer's portable consumer device account, and the merchant can be notified to prepare an extra cup of coffee. Thus, when the consumer 30 goes to pick up her coffee, there can be the extra cup provided to her. The consumer 30 may also receive another transaction notification message stating that she has reached the reward threshold. In some implementations, the merchant 22 may have a specialized pickup counter for additional purchases that can be conducted using transaction notification messages, for convenience and to encourage these extra transactions.

In certain embodiments, the additional information may include an option to upgrade a purchase, or make other additions or changes. For example, a consumer 30 may purchase tickets to a baseball game. The consumer may receive a transaction notification message stating “Purchased $100 of Yankees tickets. Buy $400 more and receive autographed baseball. Upgrade seats?” The consumer 30 may respond “yes,” upgrade her seats to premium seats, and be $50 closer to the reward threshold for earning an autographed baseball. In another example, the additional information may include an offer for adding a warranty on the products or services just purchased. In some embodiments, the additional information may include information valuable to the merchant or other entity. The additional information can comprise a survey, asking for feedback from the consumer on the purchase or the reward program.

Embodiments disclosed herein have technical advantages. For example, processing the loyalty transaction along with the purchase authorization allows for efficient generation of transaction notification messages. Thus, transaction notification messages including reward status notifications may be sent quickly, such as in real time or near real time. This allows consumers to receive the messages while still within the transaction location, and to act on the messages received, such as by purchasing more products to receive further rewards. Furthermore, consumers may keep track of their status in reward programs. Many consumers enroll in reward programs only to quickly forget about the program, without redeeming any rewards. Embodiments disclosed herein allow consumers to quickly and effectively know how many rewards they have earned, and how many they need to earn to achieve a reward threshold. Thus, the consumers may be less likely to earn rewards that go unredeemed.

III. Portable Devices and Computer Apparatuses

Accounts associated with the portable consumer device may be used for purchase transactions. Embodiments of the portable consumer device itself may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor) such as payment cards, keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

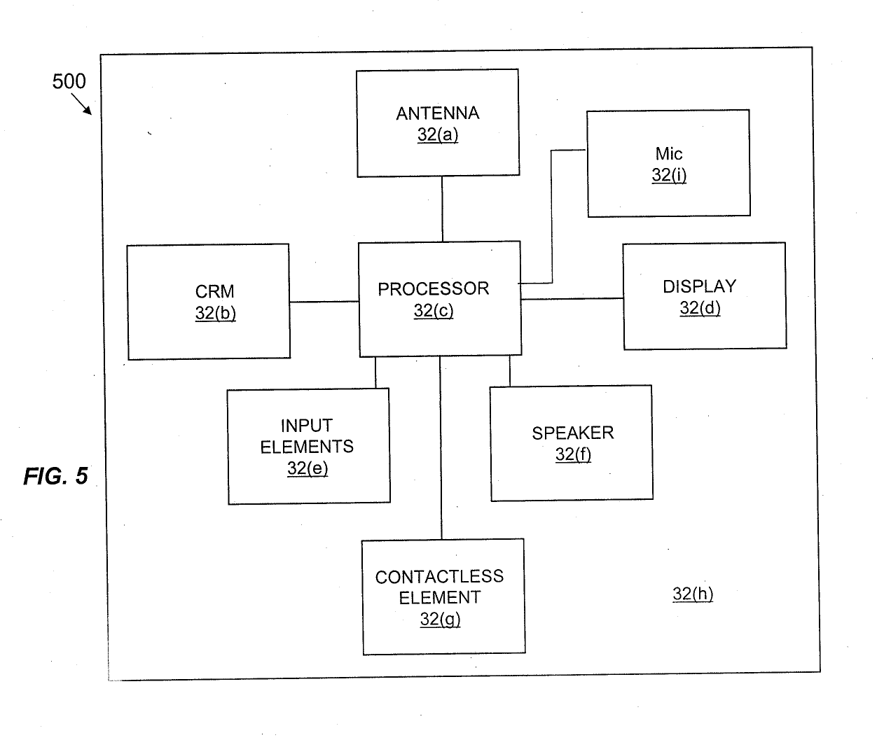

In certain embodiments, a consumer may have a single device that functions as both a portable consumer device 32 and a notification device 36. For instance, the consumer 30 may have a wireless phone that can be used to conduct transactions and to receive messages. An exemplary notification device and portable consumer device 500 in the form of a phone may comprise a computer readable medium and a body as shown in FIG. 5. (FIG. 5 shows a number of components, and the portable consumer devices according to embodiments of the invention may comprise any suitable combination or subset of such components.) The computer readable medium 32(b) may be present within the body 32(h), or may be detachable from it. The body 32(h) may be in the form a plastic substrate, housing, or other structure. The computer readable medium 32(b) may be a tangible memory that stores data and may be in any suitable form including a magnetic stripe, a memory chip, encryption algorithms, private keys, etc. The memory also preferably stores information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc.

Information in the memory may also be in the form of data tracks that are traditionally associated with credit cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The phone 500 may further include a contactless element 32(g), which is typically implemented in the form of a semiconductor chip (or other data storage element) with an associated wireless transfer (e.g., data transmission) element, such as an antenna. Contactless element 32(g) is associated with (e.g., embedded within) phone 500 and data or control instructions transmitted via a cellular network may be applied to contactless element 32(g) by means of a contactless element interface (not shown). The contactless element interface functions to permit the exchange of data and/or control instructions between the mobile device circuitry (and hence the cellular network) and an optional contactless element 32(g).

Contactless element 32(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the phone 500 and an interrogation device. Thus, the phone 500 is capable of communicating and transferring data and/or control instructions via both cellular network and near field communications capability.

The phone 500 may also include a processor 32(c) (e.g., a microprocessor) for processing the functions of the phone 500 and a display 32(d) to allow a consumer to see phone numbers and other information and messages such as the transaction notification messages. The phone 500 may further include input elements 32(e) to allow a consumer to input information into the device, a speaker 32(f) to allow the consumer to hear voice communication, music, etc., and a microphone 32(i) to allow the consumer to transmit her voice through the phone 500. The phone 500 may also include an antenna 32(a) for wireless data transfer (e.g., data transmission).

The phone 500 may be used by a consumer to receive and act on transaction notification messages. For example, phone 500 may comprise a smart phone with Internet access capabilities. In such example, phone 500 can receive a text message comprising a reward status indicator and additional information that includes a link to a website. The consumer may use the phone 500 to access the website and upgrade her recent purchase, submit a survey, or perform other suitable functions.

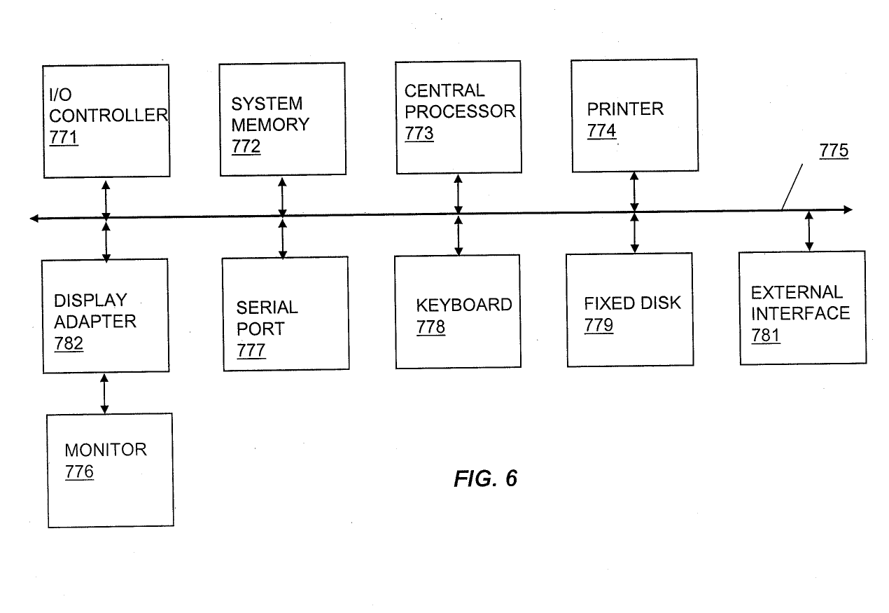

The various participants and elements in FIGS. 1-3 may operate or use one or more computer apparatuses to facilitate the functions described herein. Any of the elements previously described herein (e.g., the enrollment server 1, the loyalty program processing platform 27, the merchant 22, the notification server 29, the gateway 37, the payment processing network 26, the issuer 28 or acquirer 24, etc.) may use any suitable number of subsystems to facilitate the steps and functions described herein. Examples of such subsystems or components are shown in FIG. 6. The subsystems shown in FIG. 6 are interconnected via a system bus 775. Additional subsystems such as a printer 774, keyboard 778, fixed disk 779 (or other memory comprising computer readable media), monitor 776, which is coupled to display adapter 782, and others are shown. Peripherals and input/output (I/O) devices, which couple to I/O controller 771 (which can be a processor or other suitable controller), can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The central processor 773 can be a processor such as a microprocessor or other suitable controller. The system memory 772 and/or the fixed disk 779 may embody a computer readable medium.

Embodiments of the invention are not limited to the above-described embodiments. For example, although separate functional blocks are shown for an issuer, acquirer, payment processing system, loyalty program processing platform, notification server, gateway, or enrollment server, some entities perform some or all of these functions and may be included in embodiments of invention.

It should be understood that the present invention as described above can be implemented in the form of control logic using computer software in a modular or integrated manner. Based on the disclosure and teachings provided herein, a person of ordinary skill in the art can know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a tangible computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above descriptions are illustrative and are not restrictive. Many variations of the embodiments described herein will become apparent to those skilled in the art upon review of the disclosure. The scope of the embodiments should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. A recitation of “she” is meant to be gender neutral, and may be read as “he” or “she”, unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving a first transaction notification message comprising a first reward status indicator at a notification device, wherein the first reward status indicator indicates a first status of a consumer's purchases toward a reward threshold; and
receiving a second transaction notification message comprising a second reward status indicator at the notification device,
wherein the second reward status indicator indicates a second status of the consumer's purchases toward the reward threshold, wherein the second status is closer to the reward threshold than the first status.

2. The method of claim 1 wherein the first and second transaction notification messages are sent through a mobile gateway.

3. The method of claim 1 further comprising, prior to receiving the first transaction notification message, conducting a first purchase transaction, and wherein the method further comprises:
conducting a second purchase transaction at the merchant, wherein a second transaction notification message is received after the second purchase transaction is conducted, and
wherein the first purchase transaction and the second purchase transaction are conducted using a portable consumer device in the form of a payment card.

4. The method of claim 1 wherein both the first status and the second status are less than the reward threshold.

5. The method of claim 1 wherein the first transaction notification message is received while the consumer is at the merchant.

6. The method of claim 1 wherein the first transaction notification message is received in near real time.

7. The method of claim 1 wherein the reward threshold corresponds to a selectable number of purchases made at the merchant.

8. The method of claim 1 wherein the notification device comprises a wireless phone.

9. A method comprising:
receiving transaction data relating to a purchase transaction conducted by a consumer at a merchant;
determining, using one or more computer apparatuses, a first status of the consumer's purchases toward a reward threshold;
generating, using the one or more computer apparatuses, a first transaction notification message comprising a first reward status indicator, wherein the first reward status indicator indicates the first status;
sending the first transaction notification message to a notification device used by the consumer;
determining, using the one or more computer apparatuses, a second status of the consumer's purchases toward the reward threshold, wherein the second status is closer to the reward threshold than the first status;
generating, using the one or more computer apparatuses, a second transaction notification message comprising a second reward status indicator, wherein the second reward status indicator indicates the second status; and
sending the second transaction notification message to the notification device used by the consumer.

10. The method of claim 9, wherein the reward status indicator comprises a fraction.

11. The method of claim 9, wherein the transaction data is first transaction data and wherein the purchase transaction is a first purchase transaction, and wherein the method further comprises:
receiving second transaction data regarding a second purchase transaction conducted by the consumer, wherein the second status is determined after the second purchase transaction is conducted.

12. The method of claim 9, wherein sending the first transaction notification message occurs in near real time.

13. The method of claim 9, wherein sending the second transaction notification message occurs in near real time.

14. A computer readable medium comprising code executable by a processor, the code for implementing the method according to claim 9.

15. A server computer comprising the computer readable medium of claim 14.

16. A method comprising:
enrolling, using one or more computer apparatuses, a reward program with a payment processing network;
conducting a first purchase transaction with a consumer;
sending transaction data regarding the first purchase transaction to the payment processing network, wherein the payment processing network sends the consumer a first transaction notification message comprising a first reward status indicator, wherein the first reward status indicator indicates a first status of a consumer's purchases toward a reward threshold;
conducting a second purchase transaction with the consumer; and
sending transaction data regarding the second purchase transaction to the payment processing network, wherein the payment processing network sends the consumer a second transaction notification message comprising a second reward status indicator, wherein the second reward status indicator indicates a second status of a consumer's purchases toward the reward threshold, and wherein the second status is closer to the reward threshold than the first status.

17. The method of claim 16, wherein the payment processing network sends the consumer the first transaction notification message in near real time and sends the second transaction notification message in near real time.

18. A computer readable medium comprising code executable by a processor, the code for implementing the method according to claim 16.

19. A server computer comprising the computer readable medium of claim 14.
